(19) United States
(12) Patent Application Publication
(10) Pub. No.: US 2025/0172190 A1
(43) Pub. Date: May 29, 2025

(54) SOLENOID, DAMPING FORCE ADJUSTMENT MECHANISM, AND DAMPING FORCE ADJUSTABLE SHOCK ABSORBER

(71) Applicant: Hitachi Astemo, Ltd., Hitachinaka-shi, Ibaraki (JP)

(72) Inventors: Ryuichi SUKA, Hitachinaka-shi, Ibaraki (JP); Hiroshi YAMAGAI, Hitachinaka-shi, Ibaraki (JP); Gota NAKANO, Hitachinaka-shi, Ibaraki (JP); Seiryo KONAKAI, Hitachinaka-shi, Ibaraki (JP)

(21) Appl. No.: 18/834,434

(22) PCT Filed: Jan. 5, 2023
(86) PCT No.: PCT/JP2023/000037

§ 371 Date: Jul. 30, 2024

(30) Foreign Application Priority Data
Feb. 17, 2022 (JP) 2022-022763

(51) Int. Cl. F16F 9/50; B60G 13/08; B60G 17/0165; B60G 17/08; F16F 9/34; H01F 7/08; H01F 7/16

(52) U.S. Cl. CPC F16F 9/50; F16F 9/34; H01F 7/081; H01F 7/16; B60G 13/08; B60G 17/0165; B60G 17/08; B60G 2202/24; B60G 2204/62; B60G 2206/41; B60G 2500/104; B60G 2600/184; B60G 2800/162; B60G 2800/916; F16F 2222/12; F16F 2228/066; F16F 2230/18

(57) ABSTRACT

The present invention provides a solenoid, a damping force adjustment mechanism, and a damping force adjustable shock absorber capable of securing a thrust force of a mover (a moving core) and also suppressing a vibration at the same time. The solenoid includes a coil, an armature, an anchor, and an actuation pin. The coil generates a magnetic field in reaction to power supply thereto. The armature is at least partially located on an inner peripheral side of the coil, and is provided axially movably. The anchor faces the armature axially. The actuation pin is displaced integrally with the armature. The armature includes a large-diameter portion and a small-diameter portion. In this case, the small-diameter portion is provided on the anchor side.

### TECHNICAL FIELD

The present disclosure relates to, for example, a solenoid, a damping force adjustment mechanism, and a damping force adjustable shock absorber.

### BACKGROUND ART

Vehicles such as four-wheeled automobiles are equipped with shock absorbers (dampers) between the vehicle body (sprung) side and each wheel (unsprung) side. One known example of such shock absorbers of vehicles is a damping force adjustable hydraulic shock absorber that variably adjusts a damping force according to the running condition, the behavior of the vehicle, and/or the like. The damping force adjustable hydraulic shock absorber forms a semi-active type suspension of the vehicle.

The damping force adjustable hydraulic shock absorber variably adjusts the damping force to generate by, for example, adjusting the valve-opening pressure of a damping force adjustment valve using a damping force variable actuator. For example, a solenoid is used as the damping force variable actuator. In relation thereto, for example, PTL 1 discusses a solenoid including a cutout portion serving as a portion uneven in the circumferential direction of a mover by diagonally cutting the mover (a moving core). According to this solenoid, the mover is offset to an arbitrary circumferential position, and a circumferentially uneven force is applied to bearings. Due to that, PTL 1 achieves suppression of a swing and a vibration of the mover.

### CITATION LIST

### Patent Literature

PTL 1: International Publication No. 2016-125629

### SUMMARY OF INVENTION

### Technical Problem

In the case where the cutout is formed at a position where the mover (the moving core) and the stator (the fixed core) face each other, an attraction force (a thrust force of the mover) may be reduced between the mover and the stator, making the mover less movable especially when a low electric current is applied.

An object of one aspect of the present invention is to provide a solenoid, a damping force adjustment mechanism, and a damping force adjustable shock absorber capable of securing a thrust force of a mover (a moving core) and also suppressing a vibration at the same time.

### Solution to Problem

According to one aspect of the present invention, a solenoid includes a coil configured to generate a magnetic field in reaction to power supply thereto, a moving core at least partially located on an inner peripheral side of the coil and provided movably in an axial direction of the coil, a fixed core facing the moving core in the axial direction, and a shaft portion configured to be displaced integrally with the moving core. The moving core includes a large-diameter portion and a small-diameter portion. The small-diameter portion is provided on the fixed core side.

Further, according to one aspect of the present invention, a solenoid is configured to axially drive a moving core including at least a first magnetic resistance portion based on a magnetic effect exerted when power is supplied to a coil. The solenoid includes a shaft portion mounted on the moving core, bearings supporting both end portions of the moving core, and a second magnetic resistance portion configured to allow the solenoid to exert a function of making at least the moving core radially movable based on the magnetic effect. The second magnetic resistance portion includes a cutout formed by circumferentially cutting out one axial side of the moving core.

Further, according to one aspect of the present invention, a damping force adjustable shock absorber includes a cylinder sealingly containing hydraulic fluid therein, a piston inserted in the cylinder and dividing an inside of the cylinder into a rod-side chamber and a bottom-side chamber, a piston rod having one side coupled with the piston and an opposite side extending out of the cylinder, a flow passage in which a flow of the hydraulic fluid is generated due to extension and compression of the piston rod, and a damping force adjustment valve provided in the flow passage and configured to be driven by a solenoid. The solenoid includes a coil configured to generate a magnetic field in reaction to power supply thereto, a moving core at least partially located on an inner peripheral side of the coil and provided movably in an axial direction of the coil, and a fixed core facing the moving core in the axial direction. The moving core includes a large-diameter portion and a small-diameter portion. The small-diameter portion is provided on the fixed core side.

Further, according to one aspect of the present invention, a damping force adjustment mechanism includes a coil configured to generate a magnetic field in reaction to power supply thereto, a mover located on an inner peripheral side of the coil and provided movably in an axial direction of the coil, a stator facing the mover in the axial direction, and a control valve configured to be controlled according to a movement of the mover in the axial direction. The mover includes a large-diameter portion and a small-diameter portion. The small-diameter portion is provided on the stator side.

Further, according to one aspect of the present invention, a solenoid includes a coil configured to generate a magnetic field in reaction to power supply thereto, a moving core at least partially located on an inner peripheral side of the coil and provided movably in an axial direction of the coil, a fixed core facing the moving core in the axial direction, a shaft portion configured to be displaced integrally with the moving core, and a magnetic member provided radially between the coil and the moving core. A radial space between the moving core and the magnetic member is larger on the fixed core side compared to another portion.

According to the one aspect of the present invention, the thrust force of the moving core (the mover) can be secured, and the vibration can also be suppressed at the same time.

### BRIEF DESCRIPTION OF DRAWINGS

FIG. 1 is a vertical cross-sectional view illustrating a damping force adjustable shock absorber in which a solenoid and a damping force adjustment mechanism according to an embodiment are built.

FIG. 2 is an enlarged cross-sectional view extracting and illustrating a damping force adjustment valve and the solenoid illustrated in FIG. 1.

FIG. 3 is an enlarged cross-sectional view extracting and illustrating the solenoid illustrated in FIG. 1.

FIG. 4 is an enlarged cross-sectional view of (IV) illustrated in FIG. 1.

FIG. 5 is an enlarged cross-sectional view of a position corresponding to FIG. 4, which illustrates a solenoid according to a first modification.

FIG. 6 is an enlarged cross-sectional view of a position corresponding to FIG. 4, which illustrates a solenoid according to a second modification.

FIG. 7 is an enlarged cross-sectional view of a position corresponding to FIG. 4, which illustrates a solenoid according to a third modification.

FIGS. 8 are vertical cross-sectional views illustrating moving cores (movers) according to a fourth modification to a sixth modification, respectively.

FIGS. 9 are vertical cross-sectional views and bottom views illustrating moving cores (movers) according to a seventh modification and an eighth modification, respectively.

### DESCRIPTION OF EMBODIMENTS

In the following description, a solenoid, a damping force adjustment mechanism, and a damping force adjustable shock absorber according to an embodiment will be described with reference to the attached drawings citing an example in which they are used for a damping force adjustable hydraulic shock absorber.

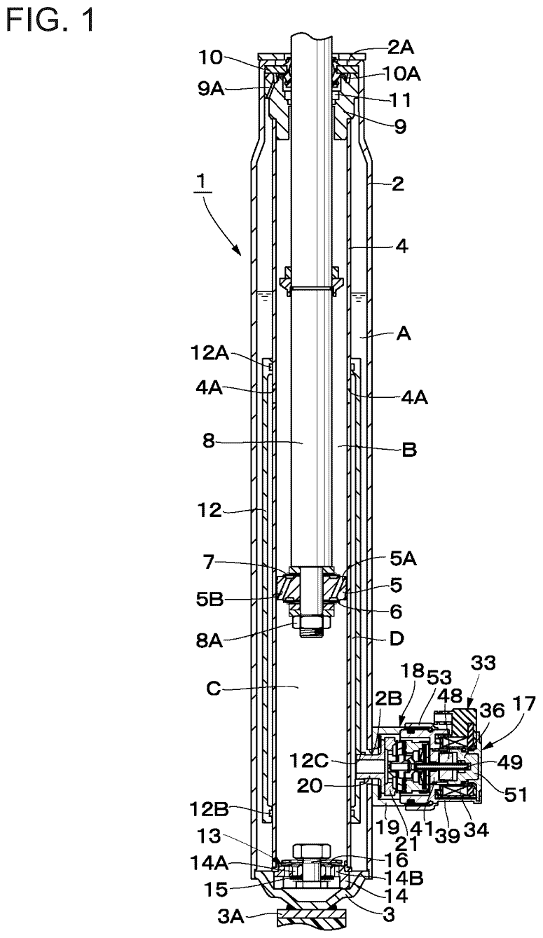

FIGS. 1 to 4 illustrate the embodiment. In FIG. 1, a damping force adjustable hydraulic shock absorber 1 (hereinafter referred to as a shock absorber 1) includes a damping force adjustment mechanism 17 using a solenoid 33 as a driving source. More specifically, the shock absorber 1 as the damping force adjustable shock absorber includes an outer tube 2 and an inner tube 4 as a cylinder, a piston 5, a piston rod 8, a rod guide 9, and a damping force adjustment mechanism 17.

The shock absorber 1, which is the hydraulic shock absorber, includes the bottomed tubular outer tube 2 constituting an outer shell. The lower end side of the outer tube 2 is closed by a bottom cap 3 with use of a welding method or the like. A radially inward bent crimped portion 2A is formed on the upper end side of the outer tube 2. The rod guide 9 and a seal member 10 are provided between the crimped portion 2A and the inner tube 4. On the other hand, an opening 2B is formed on the lower portion side of the outer tube 2 concentrically with a connection port 12C of an intermediate tube 12. The damping force adjustment mechanism 17 is attached on the lower portion side of the outer tube 2 so as to face the opening 2B. A mounting eye 3A, which is attached to, for example, a wheel side of a vehicle, is provided to the bottom cap 3.

The inner tube 4 is provided in the outer tube 2 coaxially with the outer tube 2. The lower end side of the inner tube 4 is attached to a bottom valve 13 by being fitted thereto. The upper end side of the inner tube 4 is attached to the rod guide 9 by being fitted thereto. Oil fluid as the hydraulic fluid (working fluid) is sealingly contained in the outer tube 2 and the inner tube 4 serving as the cylinder. The hydraulic fluid is not limited to oil fluid or oil, and may be, for example, water with an additive mixed therein.

An annular reservoir chamber A is formed between the inner tube 4 and the outer tube 2. Gas is sealingly contained in the reservoir chamber A together with the oil fluid. This gas may be air in an atmospheric-pressure state, or gas such as compressed nitrogen gas may be used as it. The reservoir chamber A compensates for entry and exit of the piston rod 8. An oil hole 4A is pierced radially at an intermediate position of the inner tube 4 in the length direction thereof (the axial direction). The oil hole 4A establishes constant communication of a rod-side oil chamber B with an annular oil chamber D.

The piston 5 is slidably provided in the inner tube 4. The piston 5 is inserted in the inner tube 4, and divides (partitions) the inside of the inner tube 4 into two chambers, the rod-side oil chamber B (a rod-side chamber) and a bottom-side oil chamber C (a bottom-side chamber). A plurality of oil passages 5A and a plurality of oil passages 5B are each formed on the piston 5 so as to be circumferentially spaced apart from each other. The oil passages 5A and 5B can establish communication between the rod-side oil chamber B and the bottom-side oil chamber C.

Then, an extension-side disk valve 6 is provided on the lower end surface of the piston 5. The extension-side disk valve 6 is opened upon exceedance of the pressure in the rod-side oil chamber B over a relief setting pressure when the piston 5 is slidably displaced upward during an extension stroke of the piston rod 8, and relieves the pressure at this time by releasing it to the bottom-side oil chamber C side via each of the oil passages 5A. The relief setting pressure is set to a pressure higher than a valve-opening pressure employed when the damping force adjustment mechanism 17 is set to a hard side.

A compression-side check valve 7 is provided on the upper end surface of the piston 5. The compression-side check valve 7 is opened when the piston 5 is slidably displaced downward during a compression stroke of the piston rod 8, and otherwise is closed. The check valve 7 permits a flow of the oil fluid in the bottom-side oil chamber C through each of the oil passages 5B toward the rod-side oil chamber B, and prohibits a flow of the oil fluid in an opposite direction therefrom. The valve-opening pressure of the check valve 7 is set to a pressure lower than a valve-opening pressure employed when the damping force adjustment mechanism 17 is set to a soft side, and the check valve 7 generates substantially no damping force. Generating substantially no damping force here means a force equal to or weaker than friction on the piston 5 and the seal member 10, and not affecting a motion of the vehicle.

The piston rod 8 extends axially (vertically in FIG. 1) in the inner tube 4. The lower end side of the piston 8 is inserted in the inner tube 4. The piston rod 8 is provided while being fixedly attached to the piston 5 using a nut 8A and the like. The upper end side of the piston rod 8 protrudes out of the outer tube 2 and the inner tube 4 via the rod guide 9. In other words, the lower side of the piston rod 8, which is one side, is coupled with the piston 5, and the upper side of the piston rod 8, which is an opposite side, extends out of the inner tube 4 and the outer tube 2. The piston rod 8 may be configured as a so-called double rod by further extending the lower end of the piston rod 8 to cause it to protrude outward from the bottom portion (for example, the bottom cap 3) side.

The stepped cylindrical rod guide 9 is provided on the upper end side of the inner tube 4. The rod guide 9 positions the upper portion of the inner tube 4 at the center of the outer tube 2, and also axially slidably guides the piston rod 8 on the inner peripheral side thereof. The annular seal member 10 is provided between the rod guide 9 and the crimped portion 2A of the outer tube 2. The seal member 10 is formed by, for example, baking an elastic member such as rubber to a metallic circular-ring plate including a hole provided at the center thereof for insertion of the piston rod 8. The seal member 10 seals between the piston rod 8 and the outer tube 2 with the aid of sliding contact of the inner periphery of the elastic material thereof with the outer peripheral side of the piston rod 8.

A lip seal 10A is formed on the seal member 10 on the lower surface side thereof. The lip seal 10A serves as a check valve extending so as to contact the rod guide 9. The lip seal 10A is disposed between an oil pool chamber 11 and the reservoir chamber A. The lip seal 10A permits a flow of the oil fluid and the like in the oil pool chamber 11 toward the reservoir chamber A side via a return passage 9A of the rod guide 9, and prohibits a flow in an opposite direction therefrom.

The intermediate tube 12 made of a tubular member is arranged between the outer tube 2 and the inner tube 4. The intermediate tube 12 is, for example, attached to the outer peripheral side of the inner tube 4 via upper and lower tubular seals 12A and 12B. The intermediate tube 12 forms therein the annular oil chamber D extending so as to surround the outer peripheral side of the inner tube 4 along the entire circumference thereof. The annular oil chamber D is provided as an oil chamber independent of the reservoir chamber A. The annular oil chamber D is in constant communication with the rod-side oil chamber B via the radial oil hole 4A formed through the inner tube 4. The annular oil chamber D forms a flow passage in which a flow of the hydraulic fluid is generated due to a movement of the piston rod 8. The connection port 12C is provided on the lower end side of the intermediate tube 12. A connection tubular member 20 of a damping force adjustment valve 18 is attached to the connection port 12C.

The bottom valve 13 is provided between the bottom cap 3 and the inner tube 4 at a position on the lower end side of the inner tube 4. The bottom valve 13 includes a valve body 14, a compression-side disk valve 15, and an extension-side check valve 16. The valve body 14 defines (partitions) the reservoir chamber A and the bottom-side oil chamber C between the bottom cap 3 and the inner tube 4. The compression-side disk valve 15 is provided on the lower surface side of the valve body 14. The extension-side check valve 16 is provided on the upper surface side of the valve body 14. Oil passages 14A and 14B are each formed on the valve body 14 so as to be circumferentially spaced apart from each other. The oil passages 14A and 14B can establish communication between the reservoir chamber A and the bottom-side oil chamber C.

The compression-side disk valve 15 is opened upon exceedance of the pressure in the bottom-side oil chamber C over a relief setting pressure when the piston 5 is slidably displaced downward during the compression stroke of the piston rod 8, and relieves the pressure at this time by releasing it to the reservoir chamber A side via each of the oil passages 14A. The relief setting pressure is set to a pressure higher than a valve-opening pressure employed when the damping force adjustment mechanism 17 is set to the hard side.

The extension-side check valve 16 is opened when the piston 5 is slidably displaced upward during the extension stroke of the piston rod 8, and otherwise is closed. The check valve 16 permits a flow of the oil fluid in the reservoir chamber A through each of the oil passages 14B toward the bottom-side oil chamber C, and prohibits a flow of the oil fluid in an opposite direction therefrom. The valve-opening pressure of the check valve 16 is set to a pressure lower than a valve-opening pressure employed when the damping force adjustment mechanism 17 is set to the soft side, and the check valve 16 generates substantially no damping force.

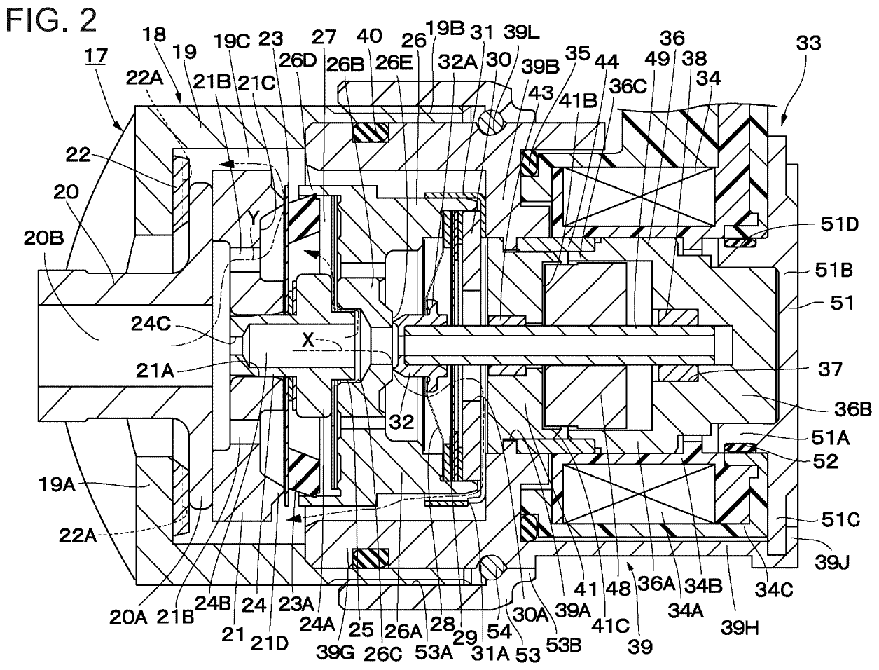

Next, the damping force adjustment mechanism 17 for variably adjusting the generated damping force of the shock absorber 1 will be described with additional reference to FIG. 2 along with FIG. 1.

The damping force adjustment mechanism 17 is a mechanism that generates the damping force by controlling a flow of the hydraulic fluid generated due to a sliding movement of the piston 5 in the cylinder (the inner tube 4), and also variably adjusts the generated damping force of the shock absorber 1. FIG. 2 illustrates the damping force adjustment mechanism 17 with an armature 48 (an actuation pin 49) moved to the left side in FIG. 2 (i.e., a valve-closing direction in which a pilot valve member 32 is seated on a valve seat portion 26E of a pilot body 26) according to power supply to a coil 34A of the solenoid 33 (for example, control of generating a hard damping force) from outside.

As illustrated in FIG. 1, the damping force adjustment mechanism 17 is disposed in such a manner that the proximal end side (the left end side in FIG. 1) thereof is interposed between the reservoir chamber A and the annular oil chamber D, and the distal end side (the right end side in FIG. 1) thereof protrudes radially outward from the lower portion side of the outer tube 2. The damping force adjustment mechanism 17 generates the damping force by controlling the flow of the oil fluid from the annular oil chamber D to the reservoir chamber A with use of the damping force adjustment valve 18. Further, the damping force adjustment mechanism 17 variably adjusts the generated damping force by adjusting the valve-opening pressure of the damping force adjustment valve 18 by the solenoid 33 used as a damping force variable actuator. In this manner, the damping force adjustment mechanism 17 generates the damping force by controlling the flow of the hydraulic fluid (the oil fluid) that is generated according to the sliding movement of the piston 5 in the inner tube 4.

More specifically, the damping force adjustment mechanism 17 includes the damping force adjustment valve 18 and the solenoid 33. The damping force adjustment valve 18 generates the damping force having the hard or soft characteristic by variably controlling the flow of the oil fluid from the annular oil chamber D to the reservoir chamber

A. The damping force adjustment valve 18 is driven by the solenoid 33. More specifically, the damping force adjustment valve 18 is a valve configured in such a manner that the valve-opening and closing operations thereof are adjusted by the solenoid 33, and is provided in a flow passage where the flow of the hydraulic liquid is generated due to the movement (extension and compression) of the piston rod 8 (for example, between the annular oil chamber D and the reservoir chamber A). The solenoid 33 adjusts the valve-opening and closing operations of the damping force adjustment valve 18. In other words, the valve-opening pressure of the damping force adjustment valve 18 is adjusted by the solenoid 33 used as the damping force variable actuator, and the generated damping force is variably controlled to the hard or soft characteristic thereby.

Then, the damping force adjustment valve 18 includes a generally cylindrical valve case 19, the connection tubular member 20, and a valve member 21. The valve case 19 is provided in such a manner that the proximal end side thereof is fixedly attached to around the opening 2B of the outer tube 2 and the distal end side thereof protrudes radially outward from the outer tube 2. The connection tubular member 20 is provided in such a manner that the proximal end side thereof is fixed to the connection port 12C of the intermediate tube 12, and the distal end side thereof includes an annular flange portion 20A formed thereon and is arranged inside the valve case 19 with a space generated therebetween. The valve member 21 is in abutment with the flange portion 20A of this connection tubular member 20.

As illustrated in FIG. 2, an annular inner flange portion 19A is formed on the proximal end side of the valve case 19. The inner flange portion 19A extends radially inward. An externally threaded portion 19B is formed on the distal end side of the valve case 19. A lock nut 53 is threadedly engaged with the externally threaded portion 19B. The lock nut 53 joins the valve case 19 and a yoke 39 (a one-side tubular portion 39G) of the solenoid 33. An annular oil chamber 19C, which is in constant communication with the reservoir chamber A, is defined between the inner peripheral surface of the valve case 19 and the outer peripheral surface of the valve member 21, and further between the inner peripheral surface of the valve case 19 and the outer peripheral surface of the pilot body 26 and the like. The valve case 19 and the solenoid 33 may be configured to, for example, be joined to each other with the distal end side of the valve case fixed to the yoke of the solenoid by crimping (configured to use no lock nut), besides being joined with each other using the lock nut 53.

An oil passage 20B is formed inside the connection tubular member 20. The oil passage 20B has one side in communication with the annular oil chamber D and an opposite side extending to the position of the valve member 21. Further, an annular spacer 22 is provided in a sandwiched state between the flange portion 20A of the connection tubular member 20 and the inner flange portion 19A of the valve case 19. A plurality of radially extending cutouts 22A is provided on the spacer 22. The cutouts 22A serve as radial oil passages for establishing communication between the oil chamber 19C and the reservoir chamber A. In the present embodiment, the damping force adjustment mechanism 17 is configured in such a manner that the cutouts 22A for forming the oil passages are provided on the spacer 22. However, cutouts (grooves) for forming oil passages may be radially provided on the inner flange portion 19A of the valve case 19, instead of the spacer 22. Employing such a configuration allows the spacer 22 to be omitted and contributes to reducing the number of components.

An axially extending central hole 21A is provided on the valve member 21 at the radially central position thereof. Further, a plurality of oil passage 21B is provided on the valve member 21 around the central hole 21A so as to be circumferentially spaced apart from each other. One side (the left side in FIGS. 1 and 2) of each of the oil passages 21B is in constant communication with the oil passage 20B side of the connection tubular member 20. Further, an annular recessed portion 21C and an annular valve seat 21D are provided on the end surface of the valve member 21 on an opposite side thereof (the right side in FIGS. 1 and 2). The annular recessed portion 21C is formed so as to surround the openings of the oil passages 21B on the opposite side. The annular valve seat 21D is located on the radially outer side of this annular recessed portion 21C, and a main valve 23 is seated on and separated from the annular valve seat 21D. Now, each of the oil passages 21B of the valve member 21 serves as a flow passage through which the hydraulic oil flows between the oil passage 20B of the connection tubular member 20 in communication with the annular oil chamber D and the oil chamber 19C of the valve case 19 in communication with the reservoir chamber A at a flow rate according to the valve lift of the main valve 23.

The main valve 23 is constituted by a disk valve sandwiched between the valve member 21 and a large-diameter portion 24A of a pilot pin 24 on the inner peripheral side thereof. The outer peripheral side of the main valve 23 is seated on and separated from the annular valve seat 21D of the valve member 21. An elastic seal member 23A is fixedly attached to the outer peripheral portion of the main valve 23 on the back surface side thereof by a method such as baking. The main valve 23 is opened by receiving a pressure on the oil passage 21B side of the valve member 21 (the annular oil chamber D side) and being separated from the annular valve seat 21D. As a result, the oil passages 21B of the valve member 21 (the annular oil chamber D side) are brought into communication with the oil chamber 19C (the reservoir chamber A side) via the main valve 23, and the amount (the flow rate) of the hydraulic oil flowing in a direction indicated by an arrow Y at this time is variably adjusted according to the valve lift of the main valve 23.

The pilot pin 24 is formed into a stepped cylindrical shape, and the annular large-diameter portion 24A is provided at an axially intermediate portion thereof. The pilot pin 24 includes an axially extending central hole 24B on the inner peripheral side thereof. A small-diameter hole (an orifice 24C) is formed at one end portion of the central hole 24B (the end portion on the connection tubular member 20 side). One end side (the left end side in FIGS. 1 and 2) of pilot pin 24 is press-fitted in the central hole 21A of the valve member 21, and sandwiches the main disk valve 23 between the large-diameter portion 24A and the valve member 21.

An opposite end side (the right end side in FIGS. 1 and 2) of the pilot pin 24 is fitted in a central hole 26C of the pilot body 26. In this state, axially extending oil passages 25 are formed between the central hole 26C of the pilot body 26 and the opposite end side of the pilot pin 24. These oil passages 25 are in communication with a back-pressure chamber 27 formed between the main valve 23 and the pilot body 26. In other words, the plurality of axially extending oil passages 25 is circumferentially arranged on the side surface of the pilot pin 24 on the opposite end side, and circumferential positions of the pilot pin 24 other than that are press-fitted in the central hole 26C of the pilot body 26.

The pilot body 26 is formed as a generally bottomed tubular member, and includes a cylindrical portion 26A and a bottom portion 26B. The cylindrical portion 26A includes a stepped hole formed inside it. The bottom portion 26B closes this cylindrical portion 26A. The central hole 26C, in which the opposite end side of the pilot pin 24 is fitted, is provided at the bottom portion 26B of the pilot body 26. A protrusion tubular portion 26D is integrally provided on one end side (the left end side in FIGS. 1 and 2) of the bottom portion 26B of the pilot body 26. The protrusion tubular portion 26D is located on the radially outer side, and protrudes toward the valve member 21 side along the entire circumference. The elastic seal member 23A of the main valve 23 is liquid-tightly fitted to the inner peripheral surface of the protrusion tubular portion 26D, and the back-pressure chamber 27 is formed between the main valve 23 and the pilot body 26 thereby. The back-pressure chamber 27 generates a pressure (an inner pressure or a pilot pressure) that presses the main valve 23 in a valve-closing direction, i.e., in a direction causing the main valve 23 to be seated onto the annular valve seat 21D of the valve member 21.

A valve seat portion 26E is provided on an opposite end side (the right end side in FIGS. 1 and 2) of the bottom portion 26B of the pilot body 26 so as to surround the central hole 26C. The pilot valve member 32 is seated on and separated from the valve seat portion 26E. Further, a return spring 28, a disk valve 29, a holding plate 30, and the like are arranged inside the cylindrical portion 26A of the pilot body 26. The return spring 28 biases the pilot valve member 32 in a direction away from the valve seat portion 26E of the pilot body 26. The disk valve 29 constitutes a fail-safe valve actuated when the solenoid 33 is in a state that no power is supplied thereto (when the pilot valve member 32 is maximumly separated from the valve seat portion 26B). The holding plate 30 includes an oil passage 30A formed on the central side thereof.

A cap 31 is fittedly fixed at the opening end of the cylindrical portion 26A of the pilot body 26 with the return spring 28, the disk valve 29, the holding plate 30, and the like arranged inside this cylindrical portion 26A. Cutouts 31A are formed on the cap 31 at, for example, positions of four portions circumferentially spaced apart from each other. As indicated by an arrow X in FIG. 2, the cutouts 31A serve as flow passages that allow oil fluid delivered to the solenoid 33 side via the oil passage 30A of the holding plate 30 to flow into the oil chamber 19C (the reservoir chamber A side).

The pilot valve member 32 constitutes the pilot valve (a control valve) together with the pilot body 26. The pilot valve member 32 is formed into a stepped cylindrical shape. The distal end portion of the pilot valve member 32, i.e., the distal end portion seated on and separated from the valve seat portion 26E of the pilot body 26 has a gradually narrowing tapering shape. The actuation pin 49 of the solenoid 33 is fittedly fixed inside the pilot valve member 32, and the valve-opening pressure of the pilot valve member 32 is adjusted according to power supply to this solenoid 33. As a result, the pilot valve (the pilot body 26 and the pilot valve member 32) as the control valve is controlled according to an axial movement of the actuation pin 49 (i.e., the armature 48) of the solenoid 33. A flange portion 32A, which serves as a spring bearing, is formed on the proximal end side of the pilot valve member 32 along the entire circumference thereof. The flange portion 32A constitutes the fail-safe valve by abutting against the inner peripheral portion of the disk valve 29 when the solenoid 33 is in the state that no power is supplied thereto, i.e., when the pilot valve member 32 is displaced to a fully opened position maximumly separated from the valve seat portion 26E.

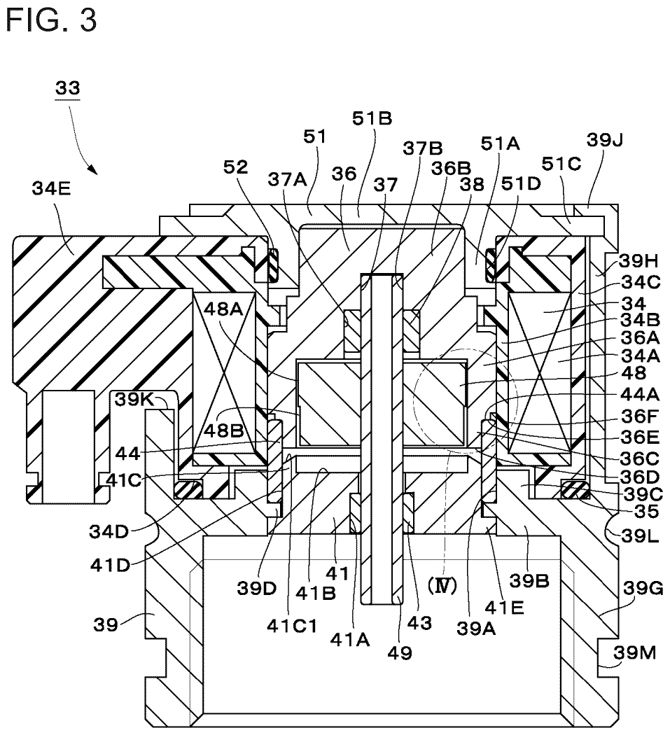

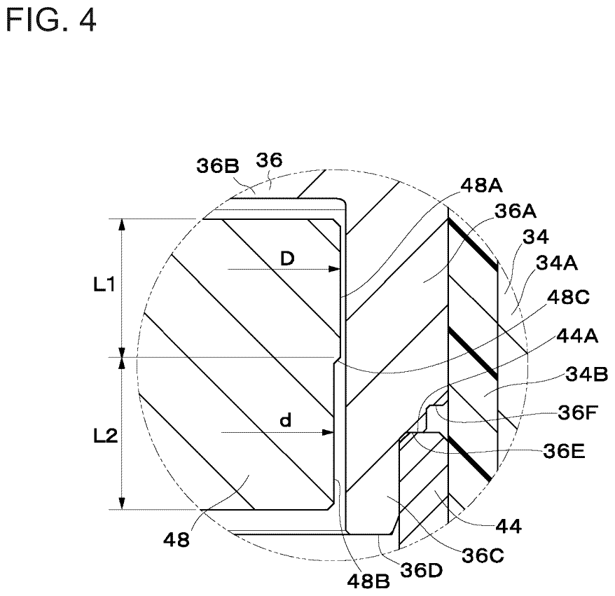

Next, the solenoid 33 constituting the damping force adjustment mechanism 17 together with the damping force adjustment valve 18 will be described with additional reference to FIGS. 3 and 4 along with FIGS. 1 and 2. In FIG. 3, the reference numerals are indicated with the right side in FIG. 2 placed on the upper side. In other words, the leftward direction and the rightward direction in FIGS. 1 and 2 correspond to the downward direction and the upward direction in FIGS. 3 and 4, respectively.

The solenoid 33 is built in the damping force adjustment mechanism 17 as the damping force variable actuator of the damping force adjustment mechanism 17. In other words, the solenoid 33 is used in a damping force adjustable shock absorber for the purpose of adjusting the valve-opening and closing operations of the damping force adjustment valve 18. The solenoid 33 includes a molded coil 34, a housing 36 as a magnetic member (a containing member), the yoke 39, an anchor 41 as a fixed core (a stator), a cylinder 44 as a joint member (a non-magnetic ring), the armature 48 as a moving core (a mover), the actuation pin 49 as a shaft portion, and a cover member 51.

The molded coil 34 is generally cylindrically formed by winding the coil 34A around a coil bobbin 34B and integrally covering (molding) them with a resin member 34C such as thermosetting resin in this state. An axially or radially outward protruding cable extraction portion 34E is provided at a circumferential part of the molded coil 34, and an electric wire cable (not illustrated) is connected to this cable extraction portion 34E. The coil 34A of the molded coil 34 is annularly wound around the coil bobbin 34B, and becomes an electromagnet and generates a magnetic field (a magnetic force) in reaction to power supply (energization) from outside via the cable.

A seal groove 34D is formed along the entire circumference on a side surface (an end surface on one axial side) of the resin member 34C of the molded coil 34 that faces the yoke 39 (an annular portion 39B). A seal member (for example, an O-ring 35) is attached in the seal groove 34D. The O-ring 35 liquid-tightly seals between the molded coil 34 and the yoke 39 (the annular portion 39B). Due to this provision, dust containing rainwater or mud water can be prevented from entering the tubular protrusion portion 39C side of the yoke 39 via between the yoke 39 and the molded coil 34.

The coil employed in the present embodiment is not limited to the molded coil 34 including the coil 34A, the coil bobbin 34B, and the resin member 34C, and another coil may also be employed. For example, the employed coil may be configured in such a manner that a coil is wound around a coil bobbin made from an electrically insulating material, and the outer periphery of the coil is covered with an overmold (not illustrated) formed by molding a resin material over it (on the outer peripheral side) in this state.

The housing 36 constitutes a magnetic member (a containing member) provided so as to be arranged on the inner peripheral side of the molded coil 34 (i.e., the inner periphery of the coil 34A). The housing 36 is formed as a lidded cylindrical tubular member from a magnetic material (a magnetic substance) such as low-carbon steel or carbon steel for machine structural use (S10C). The housing 36 includes a containing tubular portion 36A as a containing portion, a stepped lid portion 36B, and the small-diameter tubular portion 36C for joining. The containing tubular portion 36A extends in a direction of a winding axis of the molded coil 34 (the coil 34A), and has an opening on one end side thereof (the left side in FIG. 2 and the lower side in FIG. 3). The lid portion 36B closes an opposite end side (the right side in FIG. 2 and the upper side in FIG. 3) of the containing tubular portion 36A. The small-diameter tubular portion 36C is formed by reducing the diameter of the outer periphery of the containing tubular portion 36A on the opening side (one side) thereof.

The inner periphery of the cylinder 44 is joined to the outer periphery of the small-diameter tubular portion 36C of the housing 36 by brazing. The containing tubular portion 36A of the housing 36 is formed in such a manner that the inner diameter dimension thereof is slightly larger than the outer diameter dimension of the armature 48, and the armature 48 is axially movably contained in the containing tubular portion 36A. In other words, the housing 36 is opened on one axial end side thereof, and the armature 48 is contained therein. The containing tubular portion 36A of the housing 36 includes a first end portion 36D, a second end portion 36E, and a third end portion 36F in this order starting from the inner periphery of the opening end (in the order from the radially inner side to the radially outer side).

The first end portion 36D faces the anchor 41, more specifically, an outer peripheral protruding portion 41C (a reduced-diameter portion 41C1) of the anchor 41. The first end portion 36D forms a magnetic flux transfer portion for transferring the magnetic flux between the housing 36 and the armature 48. The second end portion 36E is in abutment with an opposite axial end 44A of the cylinder 44. The second end portion 36E forms a position fixation portion for positionally aligning (positioning) the housing 36 by abutting against the opposite end 44A of the cylinder 44. The third end portion 36F faces the opposite end 44A of the cylinder 44 with a space generated therebetween, and this space serves as a brazing material storage portion storing a brazing material (a copper ring) used as a sealing material. The housing 36 (the small-diameter tubular portion 36C) is press-fitted inside the cylinder 44 and is brazed, by which the housing 36 and the cylinder 44 form a pressure container.

On the other hand, the lid portion 36B of the housing 36 is integrally formed on the containing tubular portion 36A as a lidded tubular member that closes the containing tubular portion 36A from the opposite axial side. The lid portion 36B has a stepped shape smaller in outer diameter than the outer diameter of the containing tubular portion 36A, and a fitted tubular portion 51A of the cover member 51 is fittedly placed on the outer peripheral side of the lid portion 36B. Further, a bottomed stepped hole 37 is formed in the housing 36 at a position inside the lid portion 36B. The stepped hole 37 includes a bush attachment hole portion 37A and a small-diameter hole portion 37B. The small-diameter hole portion 37B is located on a deeper side and formed to have a smaller diameter than the bush attachment hole portion 37A. A first bush 38 as a bearing is provided in the bush attachment hole portion 37A. The first bush 38 is used to slidably support the actuation pin 49.

Further, the end surface of the lid portion 36B of the housing 36 on the opposite side thereof is disposed so as to face a cover plate 51B of the cover member 51 with an axial space generated therebetween. This axial space has a function of preventing an axial force from being directly applied from the cover plate 51B side of the cover member 51 to the housing 36 via the lid portion 36B. The lid portion 36B of the housing 36 does not necessarily have to be formed integrally with the containing tubular portion 36A using the same material (magnetic substance). The lid portion 36B in this case can also be made from, for example, a rigid metal material, a ceramic material, or a fiber-reinforced resin material, instead of the magnetic material. The containing tubular portion 36A and the lid portion 36B of the housing 36 are connected to each other at a position set in consideration of the transfer of the magnetic flux.

The yoke 39 is provided on one side in the direction in which the armature 48 moves. The yoke 39 is a magnetic member that generates a magnetic circuit (a magnetic path) throughout the inner peripheral side and the outer peripheral side of the molded coil 34 (the coil 34A) together with the housing 36. The yoke 39 includes the annular portion 39B and the tubular protrusion portion 39C. The annular portion 39B is formed using a magnetic material (a magnetic substance) similarly to the housing 36, and radially extends on the one axial side of the molded coil 34 (the coil 34A) (one side in the direction of the winding axis) and includes a stepped fixation hole 39A on the inner peripheral side thereof. The tubular protrusion portion 39C protrudes tubularly along the axial direction of the fixation hole 39A from the inner peripheral side of the annular portion 39B toward the opposite axial side (toward the coil 34A side). The tubular protrusion portion 39C forms a protrusion (a tubular portion) for joining to the cylinder 44, and the cylinder 44 is inserted on the radially inner side of the tubular protrusion portion 39C.

More specifically, the yoke 39 includes a fixation hole 39A, and the inner peripheral surface of the fixation hole 39A faces a part of a side surface portion 41D of the anchor 41. Further, an inward facing flange portion 39D is provided in the fixation hole 39A. The inward facing flange portion 39D protrudes radially inward along the entire circumference. The end surface of the cylinder 44 on the one axial side (one end surface) is in abutment with a side surface of the inward facing flange portion 39D (a side surface on the coil 34A side). Further, the outer periphery of the one axial side of the cylinder 44 is fitted to the inner periphery of the yoke 39, i.e., the inner surface of the fixation hole 39A (i.e., the inner peripheral surface of the tubular protrusion portion 39C).

Further, the yoke 39 is formed as an integrated member including the cylindrical one-side tubular portion 39G, an opposite-side tubular portion 39H, and a crimped portion 39J. The one-side tubular portion 39G extends from the outer peripheral side of the annular portion 39B toward the one axial side (the damping force adjustment valve 18 side). The opposite-side tubular portion 39H extends from the outer peripheral side of the annular portion 39B toward the opposite axial side (the cover member 51 side), and is formed so as to surround the molded coil 34 from the radially outer side. The crimped portion 39J is on the distal end side of the opposite-side tubular portion 39H, and holds a flange portion 51C of the cover member 51 in a retained state. A cutout 39K is provided at the opposite-side tubular portion 39H of the yoke 39. The cutout 39K is used to expose the cable extraction portion 34E of the molded coil 34 to outside the opposite-side tubular portion 39H.

An engagement recessed portion 39L is provided between the one-side tubular portion 39G and the opposite-side tubular portion 39H of the yoke 39 (along the entire circumference or at a plurality of portions circumferentially spaced apart from each other). The engagement recessed portion 39L has a semi-circular shape in cross section so as to be opened on the outer peripheral surface of the yoke 39. The lock nut 53 is engaged with the engagement recessed portion 39L via a retaining ring 54 (refer to FIG. 2). The lock nut 53 is threadedly attached to the valve case 19 of the damping force adjustment valve 18. Further, a seal groove 39M is provided on the outer peripheral surface of the one-side tubular portion 36G along the entire circumference. An O-ring 40 (refer to FIG. 2) as a seal member is attached in the seal groove 39M. The O-ring 40 liquid-tightly seals between the yoke 39 (the one-side tubular portion 39G) and the valve case 19 of the damping force adjustment valve 18.

The anchor 41 is provided on the one side in the direction in which the armature 48 moves. The anchor 41 is disposed so as to axially face the armature 48. The anchor 41 is a fixed core (a stator) fixed in the fixation hole 39A of the yoke 39 using a method such as press-fitting. The anchor 41 is made from a magnetic material (a magnetic substance) such as low-carbon steel or carbon steel for machine structural use (S10C) similarly to the housing 36 and the yoke 39, and is formed into a shape filling the fixation hole 39A of the yoke 39 from inside. The anchor 41 is formed as a short cylindrical annular member having an axially extending through-hole 41A on the central side thereof. The surface of the anchor 41 on the one axial side (the surface that axially faces the cap 31 of the damping force adjustment valve 18 illustrated in FIG. 2) is formed so as to be a flat surface similarly to the surface of the annular portion 39B of the yoke 39 on the one side.

A circular recessed dented portion 41B is provided in a recessed manner on an opposite axial side of the anchor 41 (the surface on the opposite side that axially faces the armature 48) coaxially with the containing tubular portion 36A of the housing 36. The recessed dented portion 41B is formed as a circular groove slightly larger in diameter than the armature 48 so as to allow the armature 48 to be inserted inside it advanceably and retractably under a magnetic force. Accordingly, a cylindrical outer peripheral protrusion portion 41C is provided on the opposite side of the anchor 41. The outer peripheral surface of the outer peripheral protrusion portion 41C on the opening side thereof is formed as a conical surface so as to establish a linear (straight-line) magnetic characteristic between the anchor 41 and the armature 48.

In other words, the outer peripheral protrusion portion 41C, which is also called a corner portion, tubularly protrudes from the outer peripheral side of the anchor 41 to the opposite axial side. Then, the outer peripheral surface (the outer peripheral surface on the opening side) of the outer peripheral protrusion portion 41C is shaped like a conical surface inclined in a tapering manner so as to have an outer diameter dimension gradually reducing toward the opposite axial side (the opening side). In other words, the outer peripheral protrusion portion 41C of the anchor 41 includes a reduced diameter portion 41C1 provided at a position that faces the opening of the housing 36 (the containing tubular portion 36A) (more specifically, the first end portion 36D) and having an outer diameter reducing as it becomes closer to the opening of the containing tubular portion 36A.

Further, the side surface portion 41D is formed on the outer peripheral side of the anchor 41. The side surface portion 41D extends in a direction away from the opening of the containing tubular portion 36A of the housing 36 along the outer periphery of the outer peripheral protrusion portion 41C. A radially outward protruding annular flange portion 41E is formed at an end portion of this side surface portion 41D on the one side farther away from the opening. The annular flange portion 41E is disposed at a position largely separated from the opening end of the containing tubular portion 36A of the housing 36 to the one axial side (i.e., the end portion opposite from the recessed dented portion 41B). The annular flange portion 41E is, for example, fixed in the fixation hole 39A of the yoke 39 using a method such as press-fitting. The annular flange portion 41E serves as a fixed portion of the anchor 41 (the side surface portion 41D) to the fixation hole 39A of the yoke 39, and also serves as a portion where the flange portion 41E and the fixation hole 39A radially face each other. The side surface portion 41D of the anchor 41 (except for the annular flange portion 41E) faces the inner peripheral surface of the cylinder 44 and the inner surface of the inward facing flange portion 39D of the yoke 39 via a space (a radial space).

The anchor 41 includes the outer peripheral protrusion portion 41C and the side surface portion 41D formed integrally from a magnetic material. The anchor 41 is provided at a position that faces the opening of the containing tubular portion 36A of the housing 36. The outer peripheral protrusion portion 41C protrudes toward the opening of the containing tubular portion 36A of the housing 36. The side surface portion 41D extends from the outer periphery of the outer peripheral protrusion portion 41C in the direction away from the opening of the containing tubular portion 36A of the housing 36. The side surface portion 41D has a space with the inner peripheral surface of the cylinder 44 and the inner surface of the inward facing flange portion 39D of the yoke 39.

As illustrated in FIG. 3, a second bush 43 as a bearing is fittedly provided in the stepped through-hole 41A formed on the central (inner peripheral) side of the anchor 41. The second bush 43 is used to slidably support the actuation pin 49. On the other hand, as illustrated in FIG. 2, the pilot body 26, the return spring 28, the disk valve 29, the holding plate 30, the cap 31, and the like of the damping force adjustment valve 18 are placed by being inserted on the inner peripheral side of the one-side tubular portion 39G of the yoke 39. Further, the valve case 19 of the damping force adjustment valve 18 is fitted (externally fitted) to the outer peripheral side of the one-side tubular portion 39G.

The cylinder 44 is provided radially between the yoke 39 and the anchor 41. Further, the cylinder 44 is provided axially and radially between the yoke 39 and the housing 36. In other words, the cylinder 44 is a non-magnetic connection member (joint member) provided on the inner peripheral side of the molded coil 34 (the coil 34A) at a position between the small-diameter tubular portion 36C of the housing 36 and the tubular protrusion portion 39C of the yoke 39. The cylinder 44 is made of a non-magnetic member. More specifically, the cylinder 44 is formed as a cylindrical member (just a cylinder) from a non-magnetic material such as austenitic stainless steel.

The outer periphery of the one end side (the yoke 39 side) of the cylinder 44 in the direction of the winding axis of the molded coil 34 (the coil 34A) is joined to the inner periphery of the yoke 39 (the fixation hole 39A and the tubular protrusion portion 39C). As a result, the one axial side of the cylinder 44 is fixed to the yoke 39 serving as a stator. Further, the inner periphery of an opposite end side (the housing 36 side) of the cylinder 44 in the direction of the winding axis of the molded coil 34 (the coil 34A) is joined to the outer periphery of the housing 36 (the small-diameter tubular portion 36C). In other words, the cylinder 44 is fitted (press-fitted) to the outer side (the outer peripheral side) of the small-diameter tubular portion 36C of the housing 36, and they are joined to each other by brazing.

In the embodiment, the housing 36 and the cylinder 44, and the cylinder 44 and the yoke 39 are joined to each other via a brazing material. For example, a pure copper brazing material can be used as the brazing material. In other words, the cylinder 44 can be brazed by brazing processing under, for example, 1000° C. or higher using the brazing material (a copper ring) that is the pure copper brazing material. The brazing material may be a brazing material different from the pure copper brazing material. The brazing material may be, for example, a brass brazing material, a nickel brazing material, a gold brazing material, or a palladium brazing material. In any case, the cylinder 44 is joined to the small-diameter tubular portion 36C of the housing 36 and the tubular protrusion portion 39C of the yoke 39 by brazing

The armature 48 is disposed between the containing tubular portion 36A of the housing 36 and a recessed dented portion 41B of the anchor 41. The armature 48 is a moving core (the mover) made from a magnetic body provided movably in the direction of the winding axis of the coil 34A. In other words, the armature 48 is disposed on the inner peripheral side of the coil 34A axially movably. The armature 48 is arranged on the inner peripheral sides of the containing tubular portion 36A of the housing 36, the recessed dented portion 41B of the anchor 41, the tubular protrusion portion 39C of the yoke 39, and the cylinder 44, and is configured axially movably between the containing tubular portion 36A of the housing 36 and the recessed dented portion 41B of the anchor 41. In other words, the armature 48 is arranged on the inner peripheral sides of the containing tubular portion 36A of the housing 36 and the recessed dented portion 41B of the anchor 41, and is configured axially movably via the first and second bushes 38 and 43 and the actuation pin 49 under the magnetic force generated on the coil 34A.

The armature 48 is provided fixedly (integrally) to the actuation pin 49 extending through the central side thereof, and moves together with the actuation pin 49. The actuation pin 49 is axially slidably supported on the lid portion 36B of the housing 36 and the anchor 41 via the first and second bushes 38 and 43. Now, the armature 48 is generally cylindrically formed using a ferrous magnetic material similarly to, for example, the housing 36, the yoke 39, and the anchor 41. Then, a thrust force (an attraction force) is generated on the armature 48 in a direction for attracting the armature 48 toward inside the recessed dented portion 41B of the anchor 41 under the magnetic force generated on the coil 34A.

The actuation pin 49 is a shaft portion that transmits the thrust force of the armature 48 to the pilot valve member 32 of the damping force adjustment valve 18 (the control valve), and is made of a hollow rod. The actuation pin 49 is displaced integrally with the armature 48. More specifically, the armature 48 is integrally fixed at an axially intermediate portion of the actuation pin 49 using a method such as press-fitting, and the armature 48 and the actuation pin 49 are sub-assembled by that. The both axial sides of the actuation pin 49 are slidably supported on the lid portion 36B of the housing 36 side and the yoke 39 (the anchor 41) via the first and second bushes 38 and 43.

One end side (the end portion on the left side in FIG. 2 and the end portion on the lower side in FIG. 3) of the actuation pin 49 protrudes axially from the anchor 41 (the yoke 39), and, along therewith, the pilot valve member 32 of the damping force adjustment valve 18 is fixed to this protruding end. Therefore, the pilot valve member 32 moves axially integrally together with the armature 48 and the actuation pin 49. In other words, the valve-opening setting pressure of the pilot valve member 32 is set to a pressure value corresponding to the thrust force of the armature 48 based on power supply to the coil 34A. The armature 48 opens and closes the pilot valve of the shock absorber 1 (i.e., opens and closes the pilot valve member 32 from and to the pilot body 26) by axially moving under the magnetic force from the coil 34A.

The cover member 51 is a magnetic cover that covers the molded coil 34 from outside together with the opposite-side tubular portion 39H of the yoke 39. This cover member 51 is made from a magnetic material (a magnetic substance) as the cover member that covers the molded coil 34 from the opposite axial side, and generates a magnetic circuit (a magnetic path) outside the molded coil 34 (the coil 34A) together with the opposite-side tubular portion 39H of the yoke 39. The cover member 51 is generally formed into a covered tubular shape, and generally includes the cylindrical fitted tubular portion 51A and the cover plate 51B shaped like a circular plate, which closes the opposite end side (the end portion on the right side in FIG. 2 and the end portion on the upper side in FIG. 3) of the fitted tubular portion 51A.

Then, the fitted tubular portion 51A of the cover member 51 is configured to be fittedly inserted to the outer periphery of the lid portion 36B of the housing 36 and contain the lid portion 36B of the housing 36 inside it in this state. On the other hand, the annular flange portion 51C extending to the radially outer side of the fitted tubular portion 51A is formed on the outer peripheral side of the cover plate 51B of the cover member 51, and the outer peripheral edge of the flange portion 51C is fixed to the crimped portion 39J provided on the opposite-side tubular portion 39H of the yoke 39. Due to this configuration, the opposite-side tubular portion 39H of the yoke 39 and the cover plate 51B of the cover member 51 are preliminarily assembled (sub-assembled) with the molded coil 34 built inside them as illustrated in FIG. 3.

In this manner, the lid portion 36B of the housing 36 is fittedly attached in the fitted tubular portion 51A of the cover member 51 in the state that the molded coil 34 is built inside the opposite-side tubular portion 39H of the yoke 39 and the cover plate 51B of the cover member 51. Due to this configuration, a magnetic flux can be transferred between the fitted tubular portion 51A and the cover plate 51B of the cover member 51 and the yoke 39. Further, a seal groove 51D is formed on the fitted tubular portion 51A of the cover member 51 along the entire circumference on the outer peripheral side to which the resin member 34C of the molded coil 34 is fitted. A seal member (for example, an O-ring 52) is attached in this seal groove 51D. The O-ring 52 liquid-tightly seals between the molded coil 34 and the cover member 51 (the fitted tubular portion 51A). As a result, dust containing rainwater or mud water can be prevented from entering between the housing 36 and the molded coil 34 and further entering, for example, between the housing 36 and the cover member 51 via between the cover member 51 and the molded coil 34.

The yoke 39 and the cover member 51 are fastened to the valve base 19 of the damping force adjustment valve 18 using the lock nut 53 and the retaining ring 54 serving as fastening members as illustrated in FIG. 2 with the molded coil 34 built inside them as illustrated in FIG. 3. In this case, the retaining ring 54 is attached to the engagement recessed portion 39L of the yoke 39 prior to the lock nut 53. This retaining ring 54 partially protrudes radially outward from the engagement recessed portion 39L of the yoke 39 and works to transmit the fastening force derived from the lock nut 53 to the one-side tubular portion 39G of the yoke 39.

The lock nut 53 is formed as a stepped tubular member, and includes an internally threaded portion 53A and an engagement tubular portion 53B. The internally threaded portion 53A is located on one axial side of the lock nut 53, and is threadedly engaged with the externally threaded portion 19B of the valve case 19 on the inner peripheral side thereof. The engagement tubular portion 53B is bent radially inward in such a manner that the inner diameter dimension thereof falls below the outer diameter dimension of the retaining ring 54, and is engaged with the retaining ring 54 from outside. The lock nut 53 is a fastening member for integrally coupling the damping force adjustment valve 18 and the solenoid 33 by threadedly engaging the internally threaded portion 53A and the externally threaded portion 19B of the valve case 19 with the inner surface of the engagement tubular portion 53B in abutment with the retaining ring 54 attached to the engagement recessed portion 39L of the yoke 39.

Then, the solenoid in the above-described patent literature, PTL 1 includes the cutout formed by cutting out a circumferential part at the position where the mover (the moving core) and the stator (the fixed core) face each other. In this case, the axial attraction force (the thrust force of the mover) may be reduced between the mover and the stator, making the mover less movable especially when a low electric current is applied. Further, cutting out a circumferential part may also lead to a large change in the characteristic of the thrust force. Therefore, the conventional technique may raise the necessity of a change in the solenoid structure such as an increase in the axial length and an increase in the outer diameter to secure the thrust force while suppressing the vibration, thereby resulting in an increase in additional cost.

In any case, it is undesirable that the thrust force of the mover is reduced and the characteristic of the thrust force is changed according to the formation of the cutout on the mover. Further, it is also undesirable that the effect of suppressing the vibration falls short due to the insufficiency of the attraction force attracting the mover radially (unevenness in the radial attraction force). In light thereof, the embodiment employs the following configuration. That is, the armature 48 as the mover (the moving core) includes a large-diameter portion 48A and a small-diameter portion 48B, and the small-diameter portion 48B is disposed on the anchor 41 side, which is the fixed core (the stator). Due to that, the embodiment secures both the radial attraction force (the force for suppressing the vibration) and the axial attraction force (the thrust force) between the anchor 41 and the armature 48. In the following description, the details thereof will be described.

First, as illustrated in FIG. 1, the shock absorber 1 includes the inner tube 4 and the outer tube 2 as the cylinder, the piston 5, the piston rod 8, the annular oil chamber D serving as the flow passage (more specifically, the flow passage between the annular oil chamber D and the reservoir chamber A), and the damping force adjustment valve 18 driven by the solenoid 33. Further, as illustrated in FIG. 2, the damping force adjustment mechanism 17 includes the coil 34A, the armature 48 as the mover, the anchor 41 as the stator, and the pilot valve (the pilot body 26 and the pilot valve member 32) as the control valve and thus the damping force adjustment valve 18. Further, as illustrated in FIG. 3, the solenoid 33 includes the coil 34A, the armature 48 as the moving core, the anchor 41 as the fixed core, and the actuation pin 49 as the shaft portion. Further, the solenoid includes the housing 36 as the magnetic member.

The coil 34A generates a magnetic field in reaction to power supply thereto. The armature 48 is at least partially disposed on the inner peripheral side of the coil 34A, and is provided axially movably. In other words, the armature 48 is disposed on the inner peripheral side of the coil 34A, and is provided axially movably. The anchor 41 axially faces the armature 48. The actuation pin 49 is displaced integrally with the armature 48. The housing 36 is provided radially between the coil 34A and the armature 48.

Then, as illustrated in FIGS. 3 and 4, the armature 48 includes the large-diameter portion 48A and the small-diameter portion 48B. In this case, the small-diameter portion 48B is provided on the anchor 41 side. In other words, the radial space between the armature 48 and the housing 36 is larger on the anchor 41 side compared to the other portions. The large-diameter portion 48A has a diameter kept constant at any circumferential position (an outer diameter D), i.e., is shaped as a circumferentially continuous circular circumferential edge. The small-diameter portion 48B has a diameter kept constant at any circumferential position (an outer diameter d), i.e., is shaped as a circumferentially continuous circular circumferential edge. The large-diameter portion 48A and the small-diameter portion 48B are circular in horizontal cross section at any axial position. The large-diameter portion 48A and the small-diameter portion 48B, which are different from each other in outer diameter dimension, are connected via a stepped surface 48C.

The large-diameter portion 48A, which is the housing side facing the bottom portion (the lid portion 36B) of the housing 36, has a larger diameter compared to the small-diameter portion 48B, which is the anchor side facing the anchor 41. In other words, the large-diameter portion 48A is larger in outer diameter dimension than the small-diameter portion 48B. Assuming that D represents the outer diameter dimension of the large-diameter portion 48A and d represents the outer diameter dimension of the small-diameter portion 48B, they can be set to, for example, D=1.01 d to 1.02 d. In this case, for example, the outer diameter dimension d of the small-diameter portion 48B has a dimension equal to the configuration in which the moving core (the armature) has an outer diameter dimension kept constant axially throughout (for example, the existing product). On the other hand, the outer diameter dimension D of the large-diameter portion 48A has a diameter larger by, for example, approximately 1 to 2% of the outer diameter dimension d of the small-diameter portion 48B.

On the large-diameter portion 48A, the magnetic force is increased at a portion where the space between the large-diameter portion 48A and the housing 36 provided on the radially outer side of the armature 48 is minimized according to the manufacturing tolerance of this large-diameter portion 48A. Therefore, the large-diameter portion 48A allows the radial attraction force to have circumferential unevenness therein, thereby allowing the vibration of the armature 48 to be absorbed. On the other hand, the small-diameter portion 48B can contribute to securing an axial attraction force (the thrust force of the armature 48) by keeping the constant diameter at any circumferential position (circular in cross section). As an axial length L1, which is the axial dimension of the large-diameter portion 48A, for example, reduces, the large-diameter portion 48A becomes less effective in suppressing the vibration. When the axial length L1 of the large-diameter portion 48A and the axial length L2 of the small-diameter portion 48B are set to, for example, equal lengths, the vibration can be highly effectively suppressed. On the other hand, when the axial length L1 of the large-diameter portion 48A is longer the axial length L2 of the small-diameter portion 48B, the thrust force characteristic is significantly affected (for example, the thrust force characteristic is largely changed compared to the existing product).

In the embodiment, the axial length L1 of the large-diameter portion 48A is set to a length equal to or shorter than the axial length L2 of the small-diameter portion 48B. Therefore, the vibration can be suppressed based on the unevenness in the radial attraction force due to the large-diameter portion 48A while a reduction in the thrust force and a change in the characteristic are prevented. Further, the actuation pin 49, which is displaced integrally with the armature 48, is axially extended and is provided though the inner peripheral sides of the armature 48 and the anchor 41. Then, the actuation pin 49 includes the bushes 38 and 43 as the bearings at both the axial ends.

On the other hand, the housing 36 as the magnetic member is provided on the outer peripheral side of the armature 48. In addition thereto, a larger space is generated between the large-diameter portion 48A of the armature 48 and the housing 36 than the space between the bush 38 or 43 and the actuation pin 49. In other words, the difference between the outer diameter of the large-diameter portion 48A and the inner diameter of the housing 36 is larger than the difference between the outer diameter of the actuation pin 49 and the inner diameter of the bush 38 or 43. Therefore, the large-diameter portion 48A and the housing 36 can be prevented from abutting against (contacting) each other.

Further, the space between the armature 48 (the large-diameter portion 48A) and the housing 36 is smaller than the space (the radial space) between the armature 48 (the small-diameter portion 48B) and the anchor 41 (the outer peripheral protruding portion 41C of the recessed dented portion 41B). In other words, the difference between the outer diameter of the large-diameter portion 48A and the inner diameter of the housing 36 is smaller than the difference between the outer diameter of the small-diameter portion 48B and the inner diameter of the outer peripheral protruding portion 41C. Therefore, the small-diameter portion 48B and the anchor 41 (the recessed dented portion 41B) can be prevented from abutting against (contacting) each other.

In other words, the solenoid 33 according to the embodiment axially drives the armature 48 serving as the moving core including at least a first magnetic resistance portion based on the magnetic effect when power is supplied to the coil 34A. The solenoid 33 includes the actuation pin 49 serving as the shaft portion mounted on the armature 48, and the bushes 38 and 43 serving as the bearings supporting the both end portions of the armature 48. In addition thereto, the solenoid 33 includes a second magnetic resistance portion that allows the solenoid 33 to exert the function of making at least the armature 48 radially movable based on the magnetic effect. This second magnetic resistance portion is realized by a cutout formed by circumferentially cutting out the one axial side of the armature 48. This cutout corresponds to the small-diameter portion 48B formed on the anchor 41 side of the armature 48 by circumferentially cutting out the armature 48 along the entire circumference.

The solenoid 33, the damping force adjustment mechanism 17, and the shock absorber 1 according to the present embodiment is configured in the above-described manner, and the operations thereof will be described next.

First, when the shock absorber 1 is mounted on a vehicle such as an automobile, for example, the upper end side (the protrusion end side) of the piston rod 8 is attached to the vehicle body side of the vehicle, and the mounting eye 3A side provided on the bottom cap 3 is attached to the wheel side. Further, the solenoid 33 of the damping force adjustment mechanism 17 is connected to a control apparatus (a controller) provided on the vehicle body side of the vehicle via an electric wiring cable (both unillustrated) or the like.

When the vehicle runs, upon occurrence of a vertical vibration due to unevenness of a road surface or the like, the piston rod 8 is displaced so as to extend or compress from and into the outer tube 2, and therefore the damping force can be generated by the damping force adjustment mechanism 17 and the like and the vibration of the vehicle can be damped. At this time, the generated damping force of the shock absorber 1 can be variably adjusted by controlling a current value directed to the coil 34A of the solenoid 33 using the controller to thus adjust the valve-opening pressure of the pilot valve member 32.

For example, during the extension stroke of the piston rod 8, the compression-side check valve 7 of the piston 5 is closed due to the movement of the piston 5 in the inner tube 4. Before the disk valve 6 of the piston 5 is opened, the oil fluid in the rod-side oil chamber B is pressurized, thereby being delivered into the oil passage 20B of the connection tubular member 20 of the damping force adjustment valve 18 via the oil hole 4A of the inner tube 4, the annular oil chamber D, and the connection port 12C of the intermediate tube 12. At this time, the oil fluid flows from the reservoir chamber A into the bottom-side oil chamber C by opening the extension-side check valve 16 of the bottom valve 13 by an amount corresponding to the movement of the piston 5. When the pressure in the rod-side oil chamber B reaches the valve-opening pressure of the disk valve 6, this disk valve 6 is opened and relieves the pressure in the rod-side oil chamber B by releasing it into the bottom-side chamber C.

In the damping force adjustment mechanism 17, before the main valve 23 is opened (in a low piston speed region), the oil fluid delivered into the oil passage 20B of the connection tubular member 20 is transmitted into the pilot body 26 by passing through the central hole 21A of the valve member 21, the central hole 24B of the pilot pin 24, and the central hole 26C of the pilot body 26, and pushing and opening the pilot valve member 32, as indicated by the arrow X in FIG. 2. Then, the oil fluid transmitted into the pilot body 26 flows into the reservoir chamber A by passing through between the flange portion 32A of the pilot valve member 32 and the disk valve 29, the oil passage 30A of the holding plate 30, the cutouts 31A of the cap 31, and the oil chamber 19C of the valve case 19. When the pressure in the oil passage 20B of the connection tubular member 20, i.e., the pressure in the rod-side oil chamber B reaches the valve-opening pressure of the main valve 23 according to an increase in the piston speed, the oil fluid delivered into the oil passage 20B of the connection tubular member 20 flows into the reservoir chamber A by passing through the oil passages 21B of the valve member 21, pushing and opening the main valve 23, and passing through the oil chamber 19C of the valve case 19, as indicated by the arrow Y in FIG. 2.

On the other hand, during the compression stroke of the piston rod 8, the compression-side check valve 7 of the piston 5 is opened and the extension-side check valve 16 of the bottom valve 13 is closed due to the movement of the piston 5 in the inner tube 4. Before the bottom valve 13 (the disk valve 15) is opened, the oil fluid in the bottom-side oil chamber C flows into the rod-side oil chamber B. Along therewith, the oil fluid flows from the rod-side oil chamber B into the reservoir chamber A via the damping force adjustment valve 18 by passing through a similar route to the route during the extension stroke by an amount corresponding to the entry of the piston rod 8 into the inner tube 4. When the pressure in the bottom-side chamber C reaches the valve-opening pressure of the bottom valve 13 (the disk valve 15), the bottom valve 13 (the disk valve 15) is opened and relieves the pressure in the bottom-side oil chamber C by releasing it into the reservoir chamber A.

As a result, during the extension stroke and the compression stroke of the piston rod 8, the damping force is generated due to the orifice 24C of the pilot pin 24 and the valve-opening pressure of the pilot valve member 32 before the main valve 23 of the damping force adjustment valve 18 is opened, and is generated according to the valve lift of the main valve 23 after this main valve 23 is opened. In this case, the damping force can be directly controlled regardless of the piston speed by adjusting the valve-opening pressure of the pilot valve member 32 using the power supply to the coil 34A of the solenoid 33.

More specifically, supplying a lower current to the coil 34A to reduce the thrust force on the armature 48 leads to a reduction in the valve-opening pressure of the pilot valve member 32, thereby resulting in generation of a soft-side damping force. On the other hand, supplying a higher current to the coil 34A to increase the thrust force on the armature 48 leads to an increase in the valve-opening pressure of the pilot valve member 32, thereby resulting in generation of a hard-side damping force. At this time, the valve-opening pressure of the pilot valve member 32 causes a change in the inner pressure in the back-pressure chamber 27 in communication via the oil passages 25 on the upstream side thereof. According thereto, controlling the valve-opening pressure of the pilot valve member 32 can be accompanied by adjusting the valve-opening pressure of the main valve 23 at the same time, thereby resulting in an increase in the adjustable range of the damping force characteristic.

In a case where the thrust force on the armature 48 is lost due to, for example, disconnection of the coil 34A, the pilot valve member 32 is retracted (displaced in the direction away from the valve seat portion 26E) by the return spring 28, and the flange portion 32A of the pilot valve member 32 and the disk valve 29 abut against each other. In this state, a damping force can be generated due to the valve-opening pressure of the disk valve 29, and a required damping force can be acquired even at the time of a malfunction such as the disconnection of the coil.

Now, according to the embodiment, the armature 48 includes the large-diameter portion 48A and the small-diameter portion 48B, and the small-diameter portion 48B is disposed on the anchor 41 side. Therefore, the axial attraction force can be secured by forming the small-diameter portion 48B corresponding to the anchor 41 side of the armature 48 (i.e., the anchor side axially facing the anchor 41) so as to keep the constant diameter at any circumferential position (the circumferentially evenly continuous circular circumferential edge). As a result, the thrust force of the armature 48 can be secured. On the other hand, on the large-diameter portion 48A corresponding to the opposite anchor side of the armature 48 (the opposite side from the anchor 41), the magnetic force is increased at the portion where the space between the large-diameter portion 48A and the housing 36 is minimized according to the manufacturing tolerance of this large-diameter portion 48A. Therefore, the radial attraction force can have circumferential unevenness therein, and the vibration of the armature 48 can be absorbed. As a result, the thrust force of the armature 48 can be secured, and the vibration can also be suppressed at the same time. In this case, the thrust force equivalent to the existing product can be secured based on an increase in the diameter of the large-diameter portion 48A without changing the axial length of the armature 48 (L1+L2) by forming the small-diameter portion 48B in such a manner that, for example, the outer diameter dimension thereof matches the outer diameter dimension of this existing product (the configuration in which the outer diameter of the armature is kept constant axially throughout). Therefore, the vibration can be suppressed while the thrust force is secured without requiring a large structural change from the existing product. In addition, the small-diameter portion 48B (and the large-diameter portion 48A) can be formed, for example, just by turning machining using a lathe, and therefore additional cost can be curtailed.

According to the embodiment, the actuation pin 49 is axially extended and is provided through the inner peripheral sides of the armature 48 and the anchor 41. Therefore, the embodiment can secure the thrust force of this actuation pin 49 and also suppress the vibration in addition to allowing the elongated actuation pin 49 to be disposed on the inner peripheral sides of the armature 48 and the anchor 41.

According to the embodiment, the actuation pin 49 includes the bushes 38 and 43 serving as the bearings at both the axial ends. Therefore, the actuation pin 49, which is displaced integrally with the armature 48, can be smoothly and stably supported together with the armature 48 by the bushes 38 and 43.

According to the embodiment, the second magnetic resistance portion, which allows the solenoid 33 to exert the function of making the armature 48 radially movable, is realized by the small-diameter portion 48B formed by circumferentially cutting out the one axial side of the armature 48. Therefore, a force of making the armature 48 radially movable can be generated at the large-diameter portion 48A, which is not cut out, with the aid of the small-diameter portion 48B cut out along the entire circumference of the armature 48. As a result, the thrust force of the armature 48 can be secured, and the vibration can also be suppressed.

According to the embodiment, a larger space is generated between the large-diameter portion 48A of the armature 48 and the housing 36 than the space between the bush 38 or 43 and the actuation pin 49. Therefore, the large-diameter portion 48A of the armature 48 and the housing 36 can be prevented from abutting against (contacting) each other.

According to the embodiment, the axial length L1 of the large-diameter portion 48A is shorter than the axial length L2 of the small-diameter portion 48B. Therefore, the thrust force equivalent to the existing product can be secured by forming the small-diameter portion 48B in such a manner that, for example, the outer diameter dimension thereof matches the outer diameter dimension of the existing product (the configuration in which the outer diameter of the armature is kept constant axially throughout). Then, due to the axial length L1 of the large-diameter portion 48A that is shorter than the axial length L2 of the small-diameter portion 48B, the embodiment can acquire the effect of suppressing the vibration based on the radial attraction force (the unevenness in the radial attraction force) due to the large-diameter portion 48A while preventing a reduction in the thrust force and a change in the characteristic. As a result, the design robustness can be improved.

According to the embodiment, the damping force adjustment valve 18 of the shock absorber 1 is driven by the solenoid 33. In addition thereto, the armature 48 of the solenoid 33 includes the large-diameter portion 48A and the small-diameter portion 48B, and the small-diameter portion 48B is disposed on the anchor 41 side. Therefore, the embodiment can secure the thrust force of the solenoid 33 and also suppress the vibration at the same time, and can suppress a vibration (abnormal noise) caused by cavitation of the damping force adjustment valve 18 driven by the solenoid 33. As a result, the stability of the shock absorber 1 can be improved.

According to the embodiment, the armature 48 of the damping force adjustment mechanism 17 includes the large-diameter portion 48A and the small-diameter portion 48B, and the small-diameter portion 48B is disposed on the anchor 41 side. Therefore, the embodiment can secure the thrust force of the armature 48 and also suppress the vibration at the same time, and can suppress the vibration (abnormal noise) caused by cavitation of the pilot valve (the pilot body 26 and the pilot valve member 32) controlled by the armature 48 and thus the damping force adjustment valve 18.

According to the embodiment, the radial space between the armature 48 and the housing 36 is larger on the anchor 41 side compared to the other portions. Therefore, the axial attraction force can be secured by generating a radial space kept circumferentially constant in width on the anchor 41 side (i.e., the anchor side where the armature 48 and the anchor 41 axially face each other). As a result, the thrust force of the armature 48 can be secured. On the other hand, on the opposite anchor side (the opposite side from the anchor 41), the magnetic force is increased at the portion where the radial space is minimized according to the manufacturing tolerance. Therefore, the radial attraction force can have circumferential unevenness therein, and the vibration of the armature 48 can be absorbed. As a result, the thrust force of the armature 48 can be secured, and the vibration can also be suppressed at the same time.

According to the embodiment, the inner diameter of the housing 36 (the containing tubular portion 36A) is kept constant, and the outer diameter of the armature 48 is smaller on the anchor 41 side compared to the other portions. Therefore, the radial space can be increased between the armature 48 on the anchor 41 side and the housing 36 compared to the other portions by reducing the outer diameter of the armature 48 on the anchor 41 side.

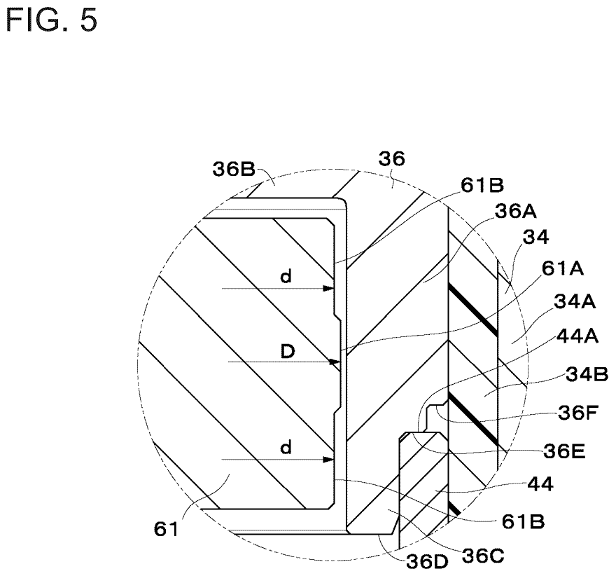

The embodiment has been described citing the example in which the armature 48 includes one large-diameter portion 48A and one small-diameter portion 48B. However, without being limited thereto, the armature 48 may be configured to include a plurality of portions as at least one of the large-diameter portion and the small-diameter portion. For example, like a first modification illustrated in FIG. 5, an armature 61 may include one large-diameter portion 61 A and a plurality of (two) small-diameter portions 61B and 61B. In this case, the armature 61 includes the first small-diameter portion 61B, the large-diameter portion 61A, and the second small-diameter portion 61B in this order starting from the anchor 41 side. The outer diameter dimension d of the small-diameter portions 61B and 61B is, for example, kept equal to the dimension of the existing product. The outer diameter dimension D of the large-diameter portion 61A is increased by, for example, approximately 1 to 2% of the outer diameter dimension d of the small-diameter portion 48B.

In a case where the first small-diameter portion 61B and the second small-diameter portion 61B have equal outer diameter dimensions, and the respective axial lengths of the large-diameter portion 61A and the small-diameter portions 61B and 61B match one another, a constraint on the direction of mounting the armature 61 is lifted. In other words, in this case, the first small-diameter portion 61B may be positioned on the anchor 41 side, or the second small-diameter portion 61B may be positioned on the anchor 41 side. This can eliminate the necessity of a determination mechanism for determining the large-diameter portion and the small-diameter portion when the armature 61 is mounted onto the solenoid 33, thereby reducing an assembling error. Not only the armature 61 may include a plurality of small-diameter portions, but also the armature 61 may include a plurality of small-diameter portions and a plurality of large-diameter portions (for example, two or more), although this is not illustrated.

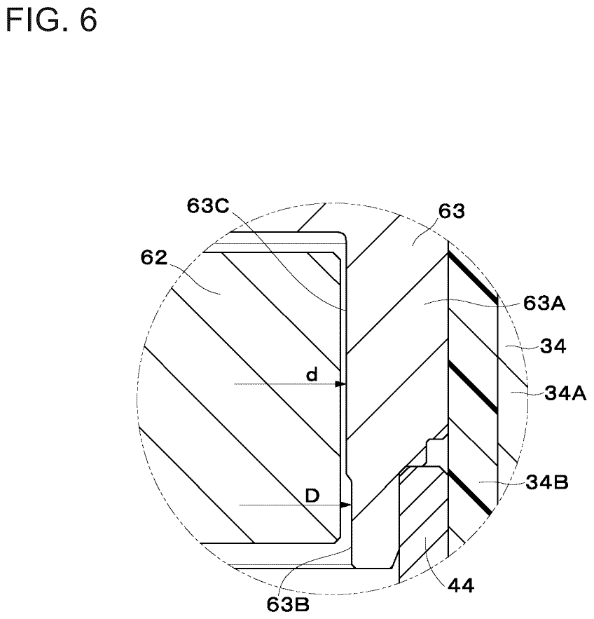

The embodiment has been described citing the example in which the inner diameter of the housing 36 (the containing tubular portion 36A) is kept constant and the outer diameter of the armature 48 is reduced on the anchor 41 side compared to the other portions. However, without being limited thereto, the diameter (the outer diameter) of an armature 62 may be kept constant and the inner diameter of a housing 63 as the magnetic member may be increased on the anchor 41 side compared to the other portions, like a second modification illustrated in FIG. 6. More specifically, in the second modification illustrated in FIG. 6, the housing 63 is provided radially between the coil 34A and the armature 62. Then, the radial space between the armature 62 and the housing 63 (the containing tubular portion 63A) is increased on the anchor 41 side compared to the other portions. In this case, the outer diameter of the armature 62 is kept constant, and the inner diameter of the housing 63 (the containing tubular portion 63A) is increased on the anchor 41 side compared to the other portions. In other words, the radially inner side of the containing tubular portion 63A of the housing 63 includes a large-diameter portion 63B having a large inner diameter dimension and a small-diameter portion 63C having a smaller inner diameter dimension than the large-diameter portion 63B, and the large-diameter portion 63B is provided on the anchor 41 side.

The outer diameter of the armature 62 is, for example, kept equal to the dimension of the existing product. Further, the inner diameter of the large-diameter portion 63B of the housing 63 (the containing tubular portion 63A) is also kept equal to the dimension of the existing product. On the other hand, the inner diameter dimension d of the small-diameter portion 63C of the housing 63 (the containing tubular portion 63A) is reduced by, for example, approximately 1 to 2% of the inner diameter dimension D of the large-diameter portion 63B. Then, for example, a reduction in the inner diameter of the housing (the containing tubular portion) axially throughout (i.e., providing only the small-diameter portion) leads to an increase in the change in the thrust force characteristic compared to the existing product. Therefore, in the second modification, the inner diameter is changed based on the large-diameter portion 63B and the small-diameter portion 63C. According to the second modification configured in this manner, a larger radial space can be generated between the armature 62 on the anchor 41 side and the housing 63 compared to the other portions by increasing the inner diameter of the anchor 41 side of the housing 63 (the containing tubular portion 63A).

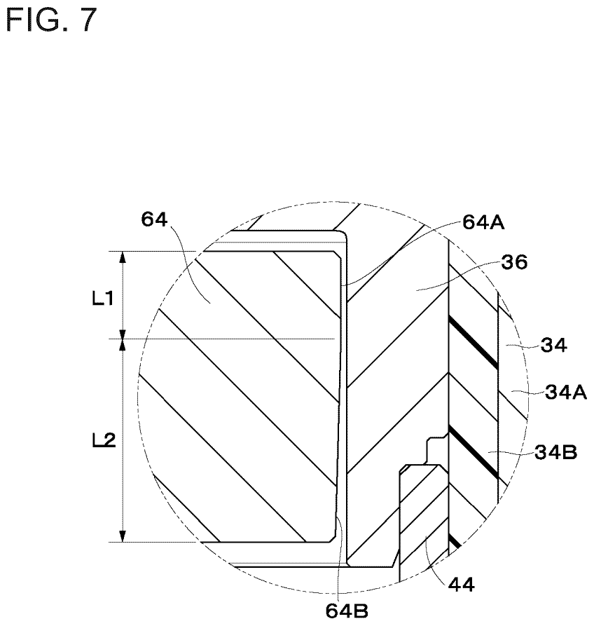

The embodiment has been described citing the example in which the outer diameter dimension d of the small-diameter portion 48B of the armature 48 is kept constant axially. However, without being limited thereto, for example, a small-diameter portion 64B of an armature 64 may have a tapered outer peripheral surface, like a third modification illustrated in FIG. 7. In other words, the small-diameter portion 64B of the armature 64 may be shaped into an inclined surface sloping in such a direction that the diameter reduces as the distance to the anchor 41 reduces. In this case, for example, the outer diameter dimension of the small-diameter portion 64B on the one side closest to the anchor 41 is equal to the configuration in which the outer diameter dimension of the moving core (the armature) is kept constant axially throughout (for example, the existing product). On the other hand, the outer diameter dimension D of the large-diameter portion 64A can be set to, for example, an outer diameter dimension larger by approximately 1 to 2% of the outer diameter dimension of the small-diameter portion 64B on the one side closest to the anchor 41. Further, the axial length L1 of the large-diameter portion 64A can be shorter than the axial length L2 of the small-diameter portion 64B.

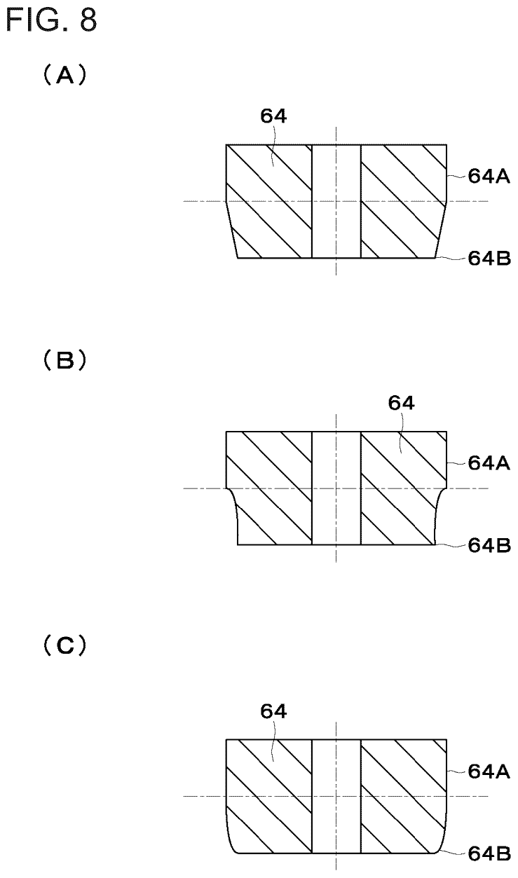

The axial length L1 of the large-diameter portion 64A is shorter than the axial length L2 of the small-diameter portion 64B in the third modification illustrated in FIG. 7, but, for example, the axial length of the large-diameter portion 64A and the axial length of the small-diameter portion 64B may be equal to each other like a fourth modification illustrated in FIG. 8 (A). Further, the outer peripheral surface of the small-diameter portion 64B is shaped into a linear inclined surface in the third modification illustrated in FIG. 7, but the small-diameter portion 64B may be shaped into, for example, a concaved curved surface (a concaved bent surface) like a fifth modification illustrated in FIG. 8(B). Alternatively, the small-diameter portion 64B may be shaped into, for example, a convexed curved surface (a convexed bent surface) like a sixth modification illustrated in FIG. 8 C).

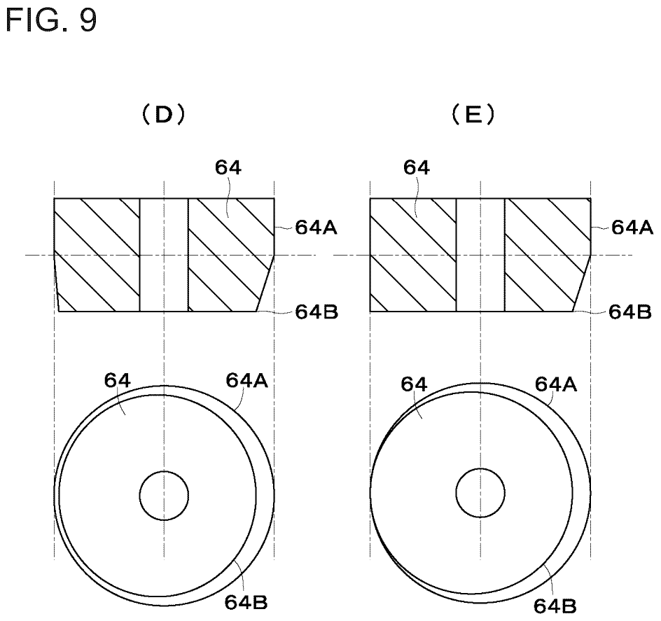

The center (the central axis) of the large-diameter portion 64A and the center of the small-diameter portion 64B on the one side closest to the anchor 41 are arranged coaxially in the fourth modification illustrated in FIG. 8(A), but, for example, the center (the central axis) of the large-diameter portion 64A and the center of the small-diameter portion 64B on the one side closest to the anchor 41 may be eccentric with respect to each other like a seventh modification illustrated in FIG. 9(D). In this case, for example, a circumferential part of the large-diameter portion 64A and a circumferential part of the small-diameter portion 64B may be axially aligned with each other like an eighth modification illustrated in FIGS. 9(E). In other words, the circumference (a circular arc in horizontal cross section) of the small-diameter portion 64B on the one side closest to the anchor 41 may be inscribed to the circumference (a circular arc in horizontal cross section) of the large-diameter portion 64A. In sum, the small-diameter portion 64B may be radially offset from the large-diameter portion 64A (the shape may be uneven between one circumferential side and an opposite circumferential side) like the seventh modification illustrated in FIG. 9(D) and the eighth modification illustrated in FIG. 9(E).

The embodiment and the modifications have been described citing the example in which the housing 36 and the cylinder 44, and the cylinder 44 and the yoke 39 are joined to each other via the brazing material. However, without being limited thereto, the housing 36 and the cylinder 44, and the cylinder 44 and the yoke 39 may be joined to each other by, for example, welding.

The embodiment and the modifications have been described citing the example in which the anchor 41 is fixed by being press-fitted in the fixation hole 39A of the yoke 39. However, without being limited thereto, the solenoid 33 may be configured in such a manner that the anchor is fixed in the yoke using, for example, a threaded engagement method such as a screw, a crimping method, or the like.

The embodiment and the modifications have been described citing the example in which the solenoid 33 is configured in such a manner that the anchor 41 and the yoke 39 are separate bodies (separate members). However, without being limited thereto, the solenoid 33 may be configured in such a manner that, for example, the anchor and the yoke are formed integrally (as one member).

The embodiment and the modifications have been described citing the example in which the solenoid 33 is configured in such a manner that the one side of the cylinder 44 is fixed to the yoke 39. However, without being limited thereto, the solenoid 33 may be configured in such a manner that, for example, the one side of the cylinder (the joint member) is fixed to the anchor.

The embodiment and the modifications have been described citing the example in which the solenoid 33 is configured in such a manner that the opposite-side tubular portion 39H is provided to the yoke 39 and the distal end side (the opposite axial side) of the opposite-side tubular portion 39H is fixed to the outer peripheral side of the cover member 51 by the crimped portion 39J. However, without being limited thereto, the solenoid 33 may be configured in such a manner that, for example, the annular portion and the opposite-side tubular portion of the yoke are formed on different members and this opposite-side tubular portion is formed integrally with the cover member.

The embodiment and the modifications have been described citing the example in which the solenoid 33 is configured as a proportional solenoid. However, without being limited thereto, the solenoid 33 may be configured as, for example, an ON/OFF-type solenoid.

The embodiment and the modifications have been described citing the twin tube-type shock absorber 1 including the outer cylinder 2 and the inner cylinder 4 by way of example. However, without being limited thereto, the present invention may be used for, for example, a damping force adjustable shock absorber constituted by a single tube-type tubular member (cylinder).

The embodiment and the modifications have been described citing the example in which the solenoid 33 is used as the damping force variable actuator of the shock absorber 1, i.e., the pilot valve member 32 forming the pilot valve of the damping force adjustment valve is set as the target driven by the solenoid 33. However, without being limited thereto, the solenoid can be widely used as an actuator built in various kinds of mechanical apparatuses such as a valve used in a hydraulic circuit, i.e., a driving apparatus that drives a driving target that should be linearly driven.

The embodiment and the modifications are only an example, and it is apparent that the configurations indicated in different embodiments and modifications can be partially replaced or combined.

According to the above-described embodiment and/or modifications (hereinafter simply referred to as the “embodiment”), the moving core includes the large-diameter portion and the small-diameter portion, and the small-diameter portion is disposed on the fixed core side. Therefore, the axial attraction force can be secured by forming the small-diameter portion side corresponding to the fixed core side of the moving core (i.e., the fixed core side axially facing the fixed core) into a small-diameter portion keeping a constant diameter at any circumferential position (the small-diameter portion having the circumferentially evenly continuous circular circumferential edge). As a result, the thrust force of the moving core can be secured. On the other hand, on the large-diameter portion side corresponding to the opposite fixed core side of the moving core, the magnetic force is increased at the portion where the space between the large-diameter portion side and the magnetic member provided on the radially outer side of the moving core is minimized according to the manufacturing tolerance of this large-diameter portion. Therefore, the radial attraction force can have circumferential unevenness therein, and the vibration of the moving core can be absorbed. As a result, the thrust force of the moving core can be secured, and the vibration can also be suppressed at the same time. In addition, the small-diameter portion can be formed just by, for example, turning machining using a lathe, and therefore additional cost can be curtailed.

According to the embodiment, the shaft portion is axially extended and is provided through the inner peripheral sides of the moving core and the fixed core. Therefore, in addition to allowing the elongated shaft portion to be disposed on the inner peripheral sides of the moving core and the fixed core, the embodiment can secure the thrust force of this shaft portion and also suppress the vibration.

According to the embodiment, the shaft portion includes the bearings at both the axial ends. Therefore, the shaft portion, which is displaced integrally with the moving core, can be smoothly and stably supported together with the moving core by the bearings.

According to the embodiment, the second magnetic resistance portion, which allows the solenoid 33 to exert the function of making the moving core radially movable, is realized by the cutout formed by circumferentially cutting out the one axial side of the moving core. Therefore, the force of making the moving core radially movable can be generated at the portion that is not cut out with the aid of the cutout that is formed by cutting out the moving core along the entire circumference thereof. As a result, the thrust force of the moving core can be secured, and the vibration can also be suppressed.

According to the embodiment, a larger space is generated between the large-diameter portion of the moving core and the magnetic member than the space between the bearing and the shaft portion. Therefore, the large-diameter portion of the moving core and the magnetic member can be prevented from abutting against (contacting) each other.

According to the embodiment, the axial length of the large-diameter portion is shorter than the axial length of the small-diameter portion. Therefore, by forming the small-diameter portion in such a manner that, for example, the outer diameter dimension thereof matches the outer diameter dimension of the configuration in which the outer diameter of the moving core is kept constant axially throughout, the thrust force equivalent to this configuration can be secured. Then, due to the axial length of the large-diameter portion that is shorter than the axial length of the small-diameter portion, the embodiment can acquire the effect of suppressing the vibration based on the unevenness of the radial attraction force due to the large-diameter portion while preventing a reduction in the thrust force and a change in the characteristic. As a result, the design robustness can be improved.

According to the embodiment, the damping force adjustment valve of the damping force adjustable shock absorber is driven by the solenoid. In addition thereto, the moving core of the solenoid includes the large-diameter portion and the small-diameter portion, and the small-diameter portion is disposed on the fixed core side. Therefore, the embodiment can secure the thrust force of the solenoid and also suppress the vibration at the same time, and can suppress the vibration (abnormal noise) caused by cavitation of the damping force adjustment valve driven by the solenoid. As a result, the stability of the damping force adjustable shock absorber can be improved.

According to the embodiment, the mover of the damping force adjustment mechanism includes the large-diameter portion and the small-diameter portion, and the small-diameter portion is disposed on the stator side. Therefore, the embodiment can secure the thrust force of the mover and also suppress the vibration at the same time, and can suppress the vibration (abnormal noise) caused by cavitation of the control valve driven by the mover.

According to the embodiment, the radial space between the moving core and the magnetic member is larger on the fixed core side compared to the other portions. Therefore, the axial attraction force can be secured by generating a radial space circumferentially constant in width on the fixed core side (i.e., the fixed core side where the moving core and the fixed core axially face each other). As a result, the thrust force of the moving core can be secured. On the other hand, on the opposite fixed core side (the opposite side from the fixed core), the magnetic force is increased at the portion where the radial space is minimized according to the manufacturing tolerance. Therefore, the radial attraction force can have circumferential unevenness therein, and the vibration of the moving core can be absorbed. As a result, the thrust force of the moving core can be secured, and the vibration can also be suppressed at the same time.

According to the embodiment, the diameter of the moving core is kept constant, and the inner diameter of the magnetic member is larger on the fixed core side compared to the other portions. Therefore, a larger radial space can be generated between the moving core on the fixed core side and the magnetic member compared to the other portions by increasing the inner diameter of the magnetic member on the fixed core side.

The present invention shall not be limited to the above-described embodiment, and includes various modifications. For example, the above-described embodiment has been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2022-022763 filed on Feb. 17, 2022. The entire disclosure of Japanese Patent Application No. 2022-022763 filed on Feb. 17, 2022 including the specification, the claims, the drawings, and the abstract is incorporated herein by reference in its entirety.

### REFERENCE SIGNS LIST

1 shock absorber (damping force adjustable shock absorber)
2 outer tube (cylinder)
4 inner tube (cylinder)
5 piston
8 piston rod
17 damping force adjustment mechanism
18 damping force adjustment valve (control valve)
32 pilot valve member (control valve)
33 solenoid
34A coil
36, 63 housing (magnetic member)
38 first bush (bearing)
41 anchor (fixed core or stator)
43 second bush (bearing)
48, 61, 62, 64 armature (moving core, mover, or first magnetic resistance portion)
48A, 61A, 62A, 64A large-diameter portion
48B, 61B, 62B, 64B small-diameter portion (cutout or second magnetic resistance portion)
49 actuation pin (shaft portion)

1-10. (canceled)

11. A solenoid comprising:
a coil configured to generate a magnetic field in reaction to power supply thereto;
a moving core at least partially located on an inner peripheral side of the coil and provided movably in an axial direction of the coil;
a fixed core facing the moving core in the axial direction;
a magnetic member disposed between the inner peripheral side of the coil and the moving core; and
a shaft portion configured to be displaced integrally with the moving core,
wherein the moving core includes a large-diameter portion and a small-diameter portion,
wherein the small-diameter portion is provided on the fixed core side,
wherein the moving core is formed in such a manner that an axial length of the large-diameter portion is shorter than an axial length of the small-diameter portion, and
wherein a space between an outer periphery of the large-diameter portion and an inner periphery of the magnetic member is smaller than a space between an outer periphery of the small-diameter portion and an inner periphery of the fixed core.

12. The solenoid according to claim 11, wherein the shaft portion is axially extended and is provided through an inner peripheral side of the moving core and an inner peripheral side of the fixed core.

13. The solenoid according to claim 11, wherein the shaft portion includes bearings at both axial end portions of the shaft portion.

14. The solenoid according to claim 13, wherein a magnetic member is provided on an outer peripheral side of the moving core, and
wherein a space between the large-diameter portion of the moving core and the magnetic member is larger than a space between the bearing and the shaft portion.

15. A damping force adjustable shock absorber comprising:
a cylinder sealingly containing hydraulic fluid therein;
a piston inserted in the cylinder and dividing an inside of the cylinder into a rod-side chamber and a bottom-side chamber;
a piston rod having one side coupled with the piston and an opposite side extending out of the cylinder;
a flow passage in which a flow of the hydraulic fluid is generated due to extension and compression of the piston rod; and
a damping force adjustment valve provided in the flow passage and configured to be driven by a solenoid,
the solenoid comprising:
a coil configured to generate a magnetic field in reaction to power supply thereto,
a moving core at least partially located on an inner peripheral side of the coil and provided movably in an axial direction of the coil,
a fixed core facing the moving core in the axial direction, and
a magnetic member disposed between the inner peripheral side of the coil and the moving core,
wherein the moving core includes a large-diameter portion and a small-diameter portion,
wherein the small-diameter portion is provided on the fixed core side,
wherein the moving core is formed in such a manner that an axial length of the large-diameter portion is shorter than an axial length of the small-diameter portion, and
wherein a space between an outer periphery of the large-diameter portion and an inner periphery of the magnetic member is smaller than a space between an outer periphery of the small-diameter portion and an inner periphery of the fixed core.

16. A damping force adjustment mechanism comprising:
a coil configured to generate a magnetic field in reaction to power supply thereto;
a mover located on an inner peripheral side of the coil and provided movably in an axial direction of the coil;
a stator facing the mover in the axial direction;
a control valve configured to be controlled according to a movement of the mover in the axial direction; and
a magnetic member disposed between the inner peripheral side of the coil and the moving core,
wherein the mover includes a large-diameter portion and a small-diameter portion,
wherein the small-diameter portion is provided on the stator side,
wherein the moving core is formed in such a manner that an axial length of the large-diameter portion is shorter than an axial length of the small-diameter portion, and
wherein a space between an outer periphery of the large-diameter portion and an inner periphery of the magnetic member is smaller than a space between an outer periphery of the small-diameter portion and an inner periphery of the fixed core.

17. The solenoid according to claim 12, wherein the shaft portion includes bearings at both axial end portions of the shaft portion.
